(19) United States
(12) Patent Application Publication
(10) Pub. No.: US 2024/0326444 A1
(43) Pub. Date: Oct. 3, 2024

(54) RECORDING DEVICE

(71) Applicant: SEIKO EPSON CORPORATION, Tokyo (JP)

(72) Inventors: Tomoya KURASHINA, SHIOJIRI-SHI (JP); Sho ARUGA, CHINO-SHI (JP); Nobuhiko SHINOZAKI, OKAYA-SHI (JP); Soshi OKAWA, SHIOJIRI-SHI (JP)

(21) Appl. No.: 18/617,911

(22) Filed: Mar. 27, 2024

(30) Foreign Application Priority Data
Mar. 30, 2023 (JP) 2023-054846

(51) Int. Cl. B41J 2/165; B41J 13/03

(52) U.S. Cl. CPC B41J 2/16544; B41J 2/16511; B41J 2/16538; B41J 13/03; B41P 2235/21

(57) ABSTRACT

A recording device includes a facing portion disposed facing a liquid discharge head and a wiper configured to wipe the head surface of the liquid discharge head by moving in the medium conveying direction with respect to the liquid discharge head. The facing portion is movable, to a recording position at which the facing portion faces the liquid discharge head and a retreat position to which the facing portion retreats from the recording position. The wiper is provided at the facing portion switchably between a first posture in which the wiper is configured to wipe the head surface and a second posture in which the wiper is farther from the head surface than in the first posture. The wiper wipes the head surface when the facing portion moves along the medium conveying direction with the wiper being in the first posture.

The present application is based on, and claims priority from JP Application Serial Number 2023-054846, filed Mar. 30, 2023, the disclosure of which is hereby incorporated by reference herein in its entirety.

### BACKGROUND

### 1. Technical Field

The present discloser relates to a recording device that performs recording on a medium.

### 2. Related Art

JP-A-2016-68503 discloses a configuration in which a wiper moves relative to a liquid discharge head to wipe the discharge surface of the liquid discharge head in a liquid discharge apparatus. The wiper is provided in a dedicated wiper holder. The wiper holder is provided with a rack. A pinion meshes with the rack. A rack and pinion mechanism moves the wiper holder to the discharge surface. The wiper holder is provided in a non-recording region in the sheet width direction. When the discharge surface is wiped by the wiper, the carriage including the liquid discharge head moves to the non-recording region.

In a case in which the liquid discharge head is a line head in which liquid discharge nozzles are provided over the entire region in the sheet width direction, if the wiper is configured to move in the sheet width direction, a long time is required for wiping. However, if the wiper is configured to move in the sheet conveying direction in order to avoid such a problem, it is difficult to secure a space for installing the wiper holder.

### SUMMARY

A recording device for solving the above problem includes a liquid discharge head including a plurality of nozzles configured to discharge liquid to a medium, the liquid discharge head being elongated in a medium width direction, the medium width direction being a direction intersecting a medium conveying direction, a facing portion disposed facing the liquid discharge head, and a wiper configured to wipe a head surface of the liquid discharge head by moving in the medium conveying direction with respect to the liquid discharge head, in which the facing portion is movable, by moving along the medium conveying direction by power of a first motor, to a recording position at which the facing portion faces the liquid discharge head and a retreat position to which the facing portion retreats from the recording position, the recording position being a position of the facing portion when recording is performed on the medium, the wiper is provided at the facing portion switchably between a first posture in which the wiper is configured to wipe the head surface and a second posture in which the wiper is farther from the head surface than in the first posture, and the wiper wipes the head surface when the facing portion moves along the medium conveying direction with the wiper being in the first posture.

### BRIEF DESCRIPTION OF THE DRAWINGS

FIG. 1 is a diagram illustrating the entire medium conveyance path of a printer.

FIG. 2 is a block diagram illustrating the control system of a printer.

FIG. 3 is a diagram illustrating the sizes of a facing portion, a wiper, a head surface, and a cap portion in a plan view.

FIG. 4 is a diagram illustrating a part of the medium conveyance path in a state in which the facing portion is at the recording position and the wiper is in the second posture.

FIG. 5 is a diagram illustrating a part of the medium conveyance path in a state in which the facing portion is at the recording position and the wiper is in the first posture.

FIG. 6 is a diagram illustrating a part of the medium conveyance path in a state in which the facing portion is at the retreat position and the wiper is in the first posture.

FIG. 7 is a view illustrating a part of the medium conveyance path and is a view of a state in which the facing portion is on the way from the retreat position to the recording position, and the wiper is in the second posture.

FIG. 8 is a diagram illustrating a configuration in which the posture of the wiper is switched by the rack and pinion mechanism.

FIG. 9 is a view illustrating another embodiment in a state in which the facing portion is at the recording position, and the wiper is in the second posture.

FIG. 10 is a view illustrating another embodiment in a state in which the facing portion is on the way from the recording position to the retreat position, and the wiper is in the first posture.

FIG. 11 is a view illustrating another embodiment in a state in which the facing portion is on the way from the recording position to the retreat position, and the wiper is in the first posture.

FIG. 12 is a view illustrating another embodiment in a state in which the facing portion is at the retreat position, and the wiper is in the first posture.

FIG. 13 is a view illustrating a rack member and a pinion for displacing the facing portion.

FIG. 14 is a view illustrating another embodiment in a state in which the facing portion is at the retreat position, and the wiper is in the second posture.

FIG. 15 is a view illustrating another embodiment in a state in which the facing portion is on the way from the retreat position to the recording position, and the wiper is in the second posture.

FIG. 16 is a diagram illustrating a state transition of a cap unit according to another embodiment.

### DESCRIPTION OF EMBODIMENTS

Hereinafter, the present disclosure will be schematically described.

A recording device according to a first aspect includes a liquid discharge head including a plurality of nozzles configured to discharge liquid to a medium, the liquid discharge head being elongated in a medium width direction that is a direction intersecting a medium conveying direction, a facing portion disposed facing the liquid discharge head, and a wiper configured to wipe a head surface of the liquid discharge head by moving in the medium conveying direction with respect to the liquid discharge head. The facing portion is movable, by moving along the medium conveying direction by power of a first motor, to a recording position at which the facing portion faces the liquid discharge head and a retreat position to which the facing portion retreats from the recording position, the recording position being a position of the facing portion when recording is performed on the medium. The wiper is provided at the facing portion switchably between a first posture in which the wiper is configured to wipe the head surface and a second posture in which the wiper is farther from the head surface than in the first posture. The wiper wipes the head surface when the facing portion moves along the medium conveying direction with the wiper being in the first posture.

According to the present aspect, since the wiper is provided on the facing portion in this manner, a dedicated holder for providing the wiper is unnecessary, and it is possible to suppress an increase in the size of the device while installing the wiper.

A second aspect is an aspect dependent on the first aspect and further includes a first conveyance roller pair located upstream of the facing portion in the medium conveying direction and configured to convey a medium. The wiper is provided at a position upstream of the facing portion in the medium conveying direction.

Since the medium is conveyed to the liquid discharge position facing the liquid discharge head by the first conveyance roller pair, if the path length between the liquid discharge position and the first conveyance roller pair becomes long, the posture of the medium is likely to become unstable, and there is a concern that the recording quality may deteriorate.

Here, if the wiper is provided at a position downstream of the facing portion, when wiping the head surface by the wiper, it is necessary to move the facing portion upstream in the medium conveying direction. Accordingly, it is necessary to increase the path length between the liquid discharge position and the first conveyance roller pair, and the above-described recording quality is likely to deteriorate.

However, according to the present aspect, since the wiper is provided at a position upstream of the facing portion in the medium conveying direction, it is possible to suppress an increase in the path length between the liquid discharge position and the first conveyance roller pair, and it is possible to suppress the above-described deterioration in recording quality.

Providing the wiper at a position upstream of the facing portion means that the wiper is provided upstream of the center position of the facing portion in the medium conveying direction. Similarly, providing the wiper at a position downstream of the facing portion means that the wiper is provided downstream of the center position of the facing portion in the medium conveying direction.

A third aspect is an aspect dependent on the second aspect, in which the wiper switches between the first posture and the second posture by being rotated by power of a second motor provided at the facing portion.

According to the present aspect, since the wiper is switched between the first posture and the second posture by being rotated by the power of the motor provided on the facing portion, it is possible to easily adjust the timing of switching the posture of the wiper.

A fourth aspect is an aspect dependent on the third aspect, in which a control unit configured to control the first motor and the second motor performs a first step of switching the wiper to the first posture in a state in which the facing portion is at the recording position and the wiper is in the second posture, and a second step of moving the facing portion from the recording position to the retreat position.

According to the present aspect, the head surface can be wiped by the wiper by the second step of moving the facing portion from the recording position to the retreat position.

A fifth aspect is an aspect dependent on the fourth aspect and further includes a cap portion located below the facing portion at the recording position and configured to cover the head surface. At least one of the liquid discharge head or the cap portion is provided movably in a direction of advancing and retreating with respect to the other of the liquid discharge head or the cap portion. The cap portion covers the head surface when at least one of the liquid discharge head or the cap portion advances with respect to the other of the liquid discharge head or the cap portion. When moving the facing portion from the retreat position to the recording position with the cap portion located below the facing portion after execution of the second step, the control unit brings the wiper into the second posture and stops the facing portion for a predetermined time with the wiper located above the cap portion.

According to the present aspect, when moving the facing portion from the retreat position to the recording position in a state in which the cap portion is located below the facing portion after the execution of the second step, the control unit brings the wiper into the second posture and stops the facing portion for a predetermined time in a state in which the wiper is located above the cap portion, so that liquid attached to the wiper can be dropped to the cap portion and collected by the cap portion.

A sixth aspect is an aspect dependent on the second aspect and further includes a second conveyance roller pair located downstream of a position facing the liquid discharge head in the medium conveying direction, the second conveyance roller pair being configured to convey a medium. The facing portion located at the retreat position is located below the second conveyance roller pair.

If the facing portion horizontally moves along the medium conveying direction, the second conveyance roller pair needs to be arranged further downstream in order to avoid interference between the second conveyance roller pair arranged downstream of the facing portion and the facing portion. When the second conveyance roller pair is disposed further downstream, the distance between the first conveyance roller pair and the second conveyance roller pair increases. As a result, the posture of the medium tends to be unstable at the position facing the liquid discharge head, and the recording quality may deteriorate.

However, according to the present aspect, since the facing portion at the retreat position is located below the second conveyance roller pair, the second conveyance roller pair can be disposed further upstream. This makes it possible to suppress the deterioration of the recording quality.

Note that the aspect is not limited to the above-described second aspect, and may also be dependent on any of the above-described third to fifth aspects.

A seventh aspect is an aspect dependent on the sixth aspect, in which the second conveyance roller pair includes a driven roller configured to come into contact with a first surface facing the liquid discharge head of a medium and a driving roller configured to come into contact with a second surface opposite to the first surface.

An eighth aspect is an aspect dependent on the fourth aspect and further includes a cap portion located below the facing portion at the recording position and configured to cover the head surface. At least one of the liquid discharge head or the cap portion is provided movably in a direction of advancing and retreating with respect to the other of the liquid discharge head or the cap portion. The cap portion covers the head surface when at least one of the liquid discharge head or the cap portion advances with respect to the other of the liquid discharge head or the cap portion. The cap portion includes a first edge portion extending in a width direction intersecting the medium conveying direction and configured to come into contact with the head surface and a second edge portion located downstream of the first edge portion in the medium conveying direction, a distance between the second edge portion and the head surface being longer than a distance between the first edge portion and the head surface in a state in which the cap portion is separated from the liquid discharge head. when moving the facing portion from the retreat position to the recording position with the cap portion located below the facing portion after execution of the second step, the control unit brings the wiper into the second posture. The wiper comes into contact with the first edge portion when the facing portion moves from the retreat position to the recording position with the wiper being in the second posture.

According to the present aspect, when moving the facing portion from the retreat position to the recording position in a state in which the cap portion is located below the facing portion after the execution of the second step, the control unit brings the wiper into the second posture. When the facing portion moves from the retreat position to the recording position while the wiper is in the second posture, the wiper comes into contact with the first edge portion. Accordingly, the liquid attached to the wiper can be removed by the second edge portion.

Hereinafter, the present disclosure will be specifically described.

An inkjet printer 1 will be described below as an example of a recording device that performs recording on a medium. Hereinafter, the inkjet printer 1 is simply referred to as the printer 1.

Note that, in an X-Y-Z coordinate system illustrated in each figure, an X-axis direction is a device width direction and is a width direction of a medium on which the recording is performed. When viewed from the operator of the printer 1, the +X direction is the left side and the −X direction is the right side.

A Y-axis direction is a device depth direction, and is along a medium conveying direction at the time of the recording. A+Y direction is a direction from the device back surface toward the front surface, and −Y direction is a direction from the device front surface toward the back surface of the device. In the present embodiment, among the side surfaces constituting the periphery of the printer 1, the side surface in the +Y direction is the device front surface, and the side surface in the −Y direction is the device back surface.

A Z-axis direction is a direction along a vertical direction, and is a device height direction. A+Z direction is the vertically upward direction, and the −Z direction is the vertically downward direction.

In the description below, a direction in which the medium is sent may be referred to as “downstream” and a direction opposite thereto may be referred to as “upstream”.

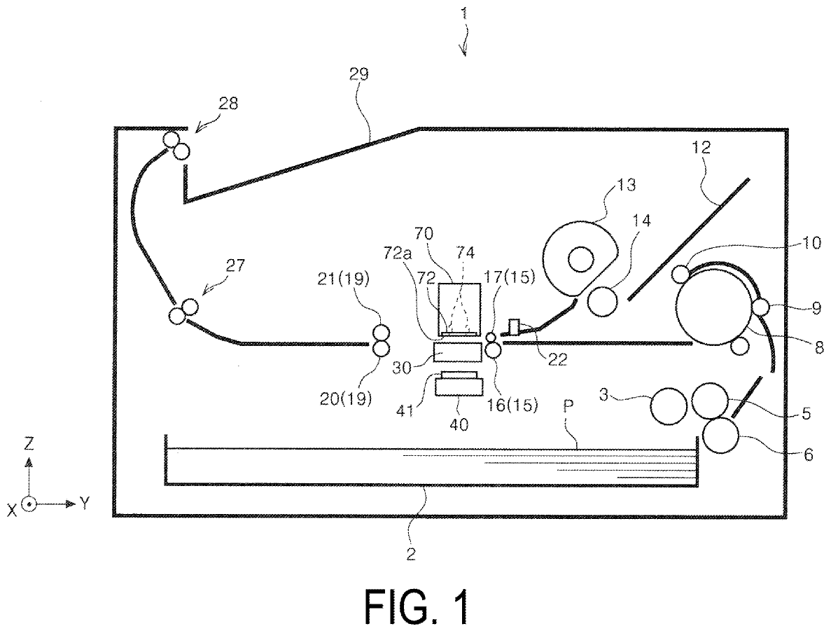

Next, the medium conveyance path of the printer 1 will be described with reference to FIG. 1. As illustrated in FIG. 1, the printer 1 includes a medium storing cassette 2, which is an example of a medium storage unit, at the bottom of the device. Reference sign P denotes a medium stored in the medium storing cassette 2. An example of a medium is a recording sheet. The medium storing cassette 2 is provided so as to be detachable from the front side of the device.

A pick roller 3 driven by a motor (not illustrated) is provided on an upper portion of the medium storing cassette 2. The pick roller 3 is movable forward and backward with respect to the media stored in the medium storing cassette 2 and rotates in contact with a medium stored in the medium storing cassette 2 to feed the medium from the medium storing cassette 2 in the +Y direction.

A feeding roller 5 driven by a motor (not illustrated) and a separation roller 6 to which a rotational torque is applied by a torque limiter (not illustrated) are provided downstream of the medium storing cassette 2. The medium fed from the medium storing cassette 2 is separated by being nipped between the feeding roller 5 and the separation roller 6 and is further fed downstream.

A reversing roller 8 driven by a motor (not illustrated) is provided downstream of the feeding roller 5 and the separation roller 6. A first nip roller 9 and a second nip roller 10 are provided around the reversing roller 8, and the medium is nipped by the reversing roller 8 and the first nip roller 9, further nipped by the reversing roller 8 and the second nip roller 10, and converted. The conveying direction of the medium is reversed from the +Y direction to the −Y direction by the reversing roller 8, and the medium is conveyed downstream.

A first conveyance roller pair 15 including a driving roller 16 driven by a motor (not illustrated) and a driven roller 17 that can be driven to rotate is provided downstream of the reversing roller 8. A medium is conveyed to a position facing a line head 70 by the first conveyance roller pair 15. The printer 1 includes a medium feeding path from a medium support unit 12 in addition to the medium feeding path from the medium storing cassette 2. The medium support unit 12 supports a medium in an inclined posture, and the supported medium is conveyed to the first conveyance roller pair 15 by the feeding roller 13 driven by a motor (not illustrated). Reference sign 14 denotes a separation roller to which rotational torque is applied by a torque limiter (not illustrated).

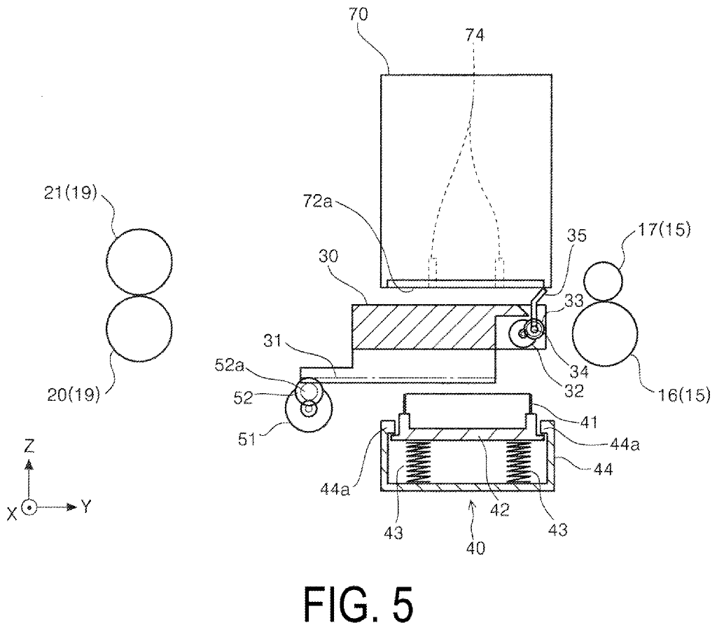

A medium detection unit 22 is provided upstream of the first conveyance roller pair 15. A control unit 50 (see FIG. 5) described later can position the leading end of a medium with respect to the line head 70 based on the detection information of the medium detection unit 22 and can position the medium at, for example, a recording start position.

The line head 70 discharges ink, which is an example of liquid discharge head, onto the image forming surface of the medium to execute recording. The line head 70 is a liquid discharge head in which a plurality of nozzles 74 that discharge ink are arranged so as to cover the entire region in the medium width direction. The line head 70 is long in the medium width direction and is configured as a liquid discharge head capable of performing recording over the entire medium width without moving in the medium width direction.

Reference sign 72a denotes a head surface that faces a medium. The head surface 72a can also be referred to as a liquid discharge surface or a nozzle surface. The head surface 72a is formed by a plate member 72. The nozzles 74 are arranged in a region of the head surface 72a.

The printer 1 includes an ink storing unit (not illustrated), and the ink discharged from the line head 70 is supplied from the ink storing unit to the line head 70 via an ink tube (not illustrated).

A facing portion 30 is provided at a position facing the head surface 72a of the line head 70. The facing portion 30 according to the present embodiment defines a gap between a medium and the head surface 72a by supporting the medium. Hereinafter, the gap between the medium and the head surface 72a may be referred to as a platen gap.

The facing portion 30 is provided so as to be movable along the medium conveying direction, which will be described later again.

A cap portion 41 that covers the head surface 72a of the line head 70 is provided below the facing portion 30. The cap portion 41 is provided on a cap unit 40.

Here, the line head 70 is provided so as to be movable in a direction in which the line head 70 advances and retreats with respect to the facing portion 30, that is, in a direction in which the platen gap is adjusted. In the present embodiment, the platen gap adjusting direction is parallel to the Z-axis direction. Hereinafter, the movement of the line head 70 in the +Z-axis direction may be referred to as “upward movement”, and the movement of the line head 70 in the −Z-axis direction may be referred to as “downward movement”.

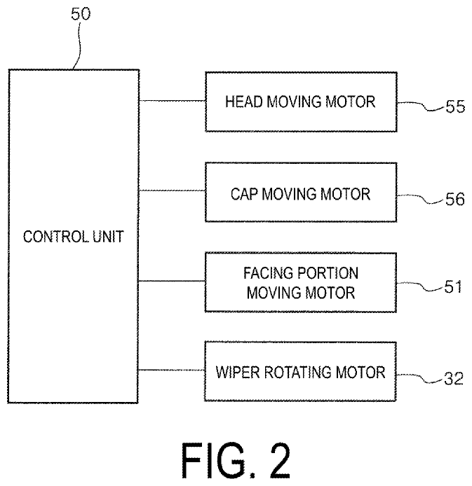

The line head 70 is displaced in the Z-axis direction by the power of a head moving motor 55 (see FIG. 2) while being guided in the Z-axis direction by a guide portion (not illustrated). The power of the head moving motor 55 is transmitted via a rack and pinion mechanism including a rack (not illustrated) provided on the line head 70 and a pinion (not illustrated) meshing with the rack. The rack and pinion mechanism is provided near both ends in the medium width direction with respect to the line head 70.

Referring to FIG. 2, reference sign 80 denotes a control unit for controlling the head moving motor 55. The control unit 50 is a control unit that controls the entire printer 1. The control unit 50 also controls a medium conveyance motor (not illustrated), the line head 70, and the like, which are not illustrated in FIG. 2.

When the line head 70 moves upward, the line head abuts on an upward movement restriction portion (not illustrated), and further upward movement is restricted. The control unit 50 detects an increase in the motor drive current value when the line head 70 abuts on the upward movement restriction portion, thereby being able to grasp that the line head 70 is located at the upward movement limit position.

Note that the head moving motor 55 is provided with an encoder sensor (not illustrated) to allow the control unit 50 to detect the rotation amount of the head moving motor 55. This enables the control unit 50 to detect the movement amount of the line head 70 from the upward movement limit position, that is, can grasp the current position of the line head 70.

Based on the medium type included in the received print data, the control unit 50 moves up and down the line head 70 according to the thickness of the medium and adjusts the platen gap. For example, assuming that the position of the line head 70 when recording is performed on plain paper is a first ink discharge position, when recording is performed on special paper thicker than plain paper, the line head 70 is positioned at a second ink discharge position higher than the first ink discharge position.

Note that the movement region of the line head 70 includes a cap position that is a position when capped by a cap portion 41 described later in addition to the plurality of recording positions as described above.

In the present embodiment, the above-described respective positions of the line head 70 include a cap position, a first ink discharge position, and a second ink discharge position in order toward the +Z direction.

The cap unit 40 is also provided so as to be movable in the Z-axis direction in the same manner as the line head 70. The cap unit 40 is displaced in the Z-axis direction by the power of a cap moving motor 56 (see FIG. 2) while being guided in the Z-axis direction by a guide portion (not illustrated). In the present embodiment, the cap unit 40 is displaced between the ascent position and the descent position. The ascent position is a position at which the head surface 72a of the line head 70 is capped by the cap portion 41, and the descent position is another position.

The power of the cap moving motor 56 is transmitted via a rack and pinion mechanism including a rack (not illustrated) provided on the cap unit 40 and a pinion (not illustrated) meshing with the rack. The rack and pinion mechanism is provided near both ends in the medium width direction with respect to the cap unit 40.

When the cap unit 40 moves upward, the cap unit abuts on an upward movement restriction portion (not illustrated), and further upward movement is restricted. When the cap unit 40 moves downward, the cap unit abuts on a downward movement restriction portion (not illustrated), and further downward movement is restricted. The control unit 50 detects an increase in the motor drive current value when the cap unit 40 abuts on the upward movement restriction portion or the downward movement restriction portion, so that it is possible to grasp that the cap unit 40 is located at the ascent position or the descent position.

However, the method of detecting the position of the cap unit 40 is not limited thereto, and for example, a contact type or non-contact type sensor may be used to detect the position of the cap unit 40.

In the present embodiment, the cap unit 40 moves to the ascent position and the descent position by the power of the cap moving motor 56 but may be configured to move to the ascent position and the descent position by an actuator such as a solenoid instead of the cap moving motor 56. The cap unit 40 may be fixedly provided without being displaceably provided.

When the power is turned off or in a recording standby state, the control unit 50 positions the facing portion 30 at a retreat position described below, positions the line head 70 at a capping position, and further positions the cap unit 40 at an ascent position. Thus, the head surface 72a of the line head 70 is covered with the cap portion 41.

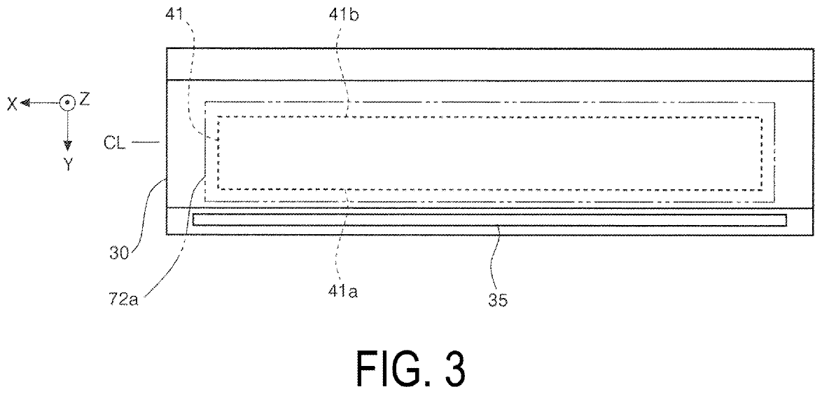

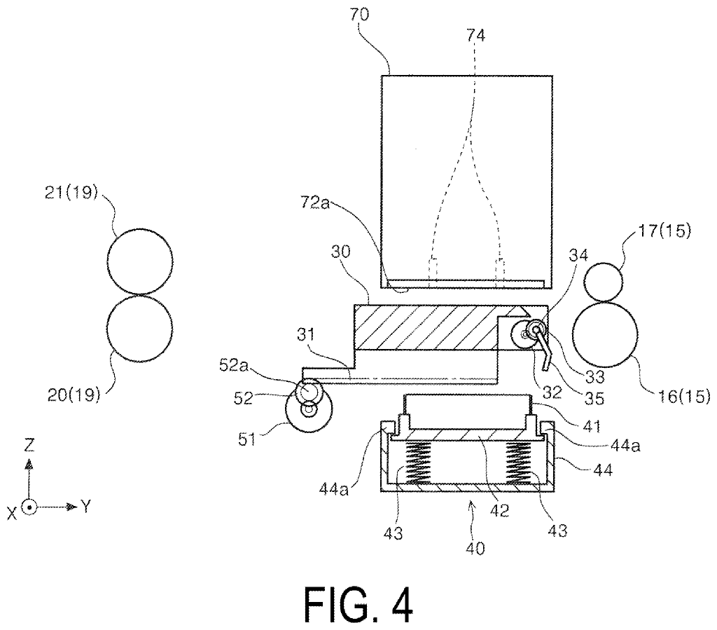

The cap portion 41 has a shape elongated in the medium width direction (see FIG. 3) and is made of an elastic material such as rubber. As illustrated in FIG. 4, the cap portion 41 is supported by a cap support portion 42 made of a resin material or the like.

The cap support portion 42 is held by a base portion 44 so as to be displaceable in the Z-axis direction, and the limit of movement in the +Z direction is defined by a restriction portion 44a formed at the base portion 44. The cap support portion 42 is pressed in the +Z direction by a cap spring 43 which is an example of a pressing member.

A waste liquid tube (not illustrated) is coupled to the cap portion 41. The waste liquid tube is coupled to a pump (not illustrated), and waste liquid is sent to a waste liquid collection unit (not illustrated) by the action of the pump. When the pump is operated with the cap portion 41 covering the head surface 72a, a negative pressure is generated in the cap portion 41, whereby ink is sucked from the nozzles 74 of the line head 70.

When the head surface 72a is covered with the cap portion 41, the cap portion 41 is slightly pushed down in the −Z direction against the pressing force of the cap spring 43, whereby the cap portion 41 comes into close contact with the head surface 72a.

Referring back to FIG. 1, a second conveyance roller pair 19 including a driving roller 20 driven by a motor (not illustrated) and a driven roller 21 capable of being driven and rotated is provided downstream of the line head 70. The driven roller 21 is a driven roller that comes into contact with the first surface of a medium which faces the line head 70, and the driving roller 20 is a driving roller that comes into contact with the second surface opposite to the first surface. The medium on which recording has been performed is conveyed downstream by the second conveyance roller pair 19.

A third conveyance roller pair 27 is provided downstream of the second conveyance roller pair 19, and a discharge roller pair 28 is further provided downstream of the third conveyance roller pair 27. A portion between the third conveyance roller pair 27 and the discharge roller pair 28 is configured as a face-down discharge path, and the medium on which recording has been performed is discharged to a discharge tray 29 by the discharge roller pair 28 in a state in which the latest recording surface faces down.

Next, the facing portion 30 and a wiper 35 will be described in detail with reference to FIG. 3 and subsequent drawings.

As illustrated in FIG. 3, the facing portion 30 is a member elongated along the medium width direction and is supported by a guide member (not illustrated) so as to be movable along the Y-axis direction which is the medium conveying direction. As illustrated in FIG. 4, a rack portion 31 is formed at the lower portion of the facing portion 30 along the medium conveying direction. A pinion gear 52 meshes with the rack portion 31, and the rack portion 31 and the pinion gear 52 constitute a rack and pinion mechanism. The rack and pinion mechanism is provided at both end portions of the facing portion 30 in the medium width direction. The pinion 52 is provided on a shaft 52a extending in the medium width direction.

A facing portion moving motor 51, which is an example of a first motor, is provided at an end portion on one side in the medium width direction, for example, an end portion in the +X direction, and the pinion gear 52, of the two pinion gears 52 provided in the medium width direction, which is provided in the +X direction is driven by the facing portion moving motor 51. When the pinion gear 52 is driven by the facing portion moving motor 51, the facing portion 30 moves along the Y-axis direction. The facing portion moving motor 51 is controlled by the control unit 50 (see FIG. 2).

When the facing portion 30 moves to the end portion in the +Y direction and the end portion in the −Y direction, the facing portion 30 comes into contact with a movement restriction portion (not illustrated), and further movement is restricted. By detecting an increase in the motor drive current value when the facing portion 30 comes into contact with the movement restriction portion, the control unit 50 can recognize that the facing portion 30 is positioned at the movement limit position in the +Y direction or can recognize that the facing portion 30 is positioned at the movement limit position in the −Y direction. However, the method of detecting the position of the facing portion 30 is not limited thereto, and for example, a contact type or non-contact type sensor may be used to detect the position of the facing portion 30.

Hereinafter, the movement limit position of the facing portion 30 in the +Y direction is referred to as a recording position, and the movement limit position of the facing portion 30 in the −Y direction is referred to as a retreat position. The recording position is the position of the facing portion 30 when recording is performed on the medium by the line head 70. The retreat position is the position of the facing portion 30 when the head surface 72a of the line head 70 is covered by the cap portion 41. The head surface 72a of the line head 70 can be covered with the cap portion 41 as the facing portion 30 moves from the recording position to the retreat position.

Next, the facing portion 30 is provided with the wiper 35 for wiping the head surface 72a of the line head 70. The wiper 35 is made of an elastic material such as rubber and can be elastically deformed when pressed against the head surface 72a.

As illustrated in FIG. 3, the wiper 35 is a member elongated in the medium width direction and is formed to have a length capable of wiping the entire region of the head surface 72a in the medium width direction.

As illustrated in FIG. 4, the wiper 35 is rotatable about a shaft 34. The shaft 34 is a shaft that is long in the medium width direction and is supported so as to be rotatable with respect to the facing portion 30.

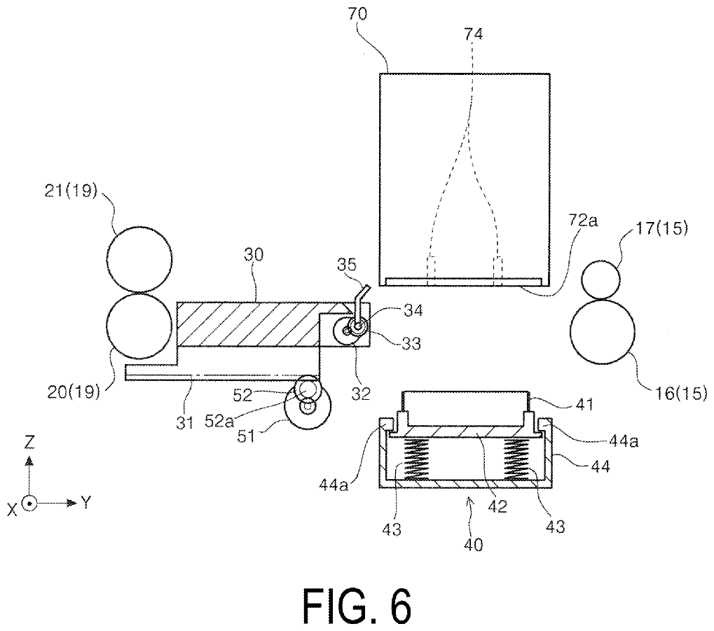

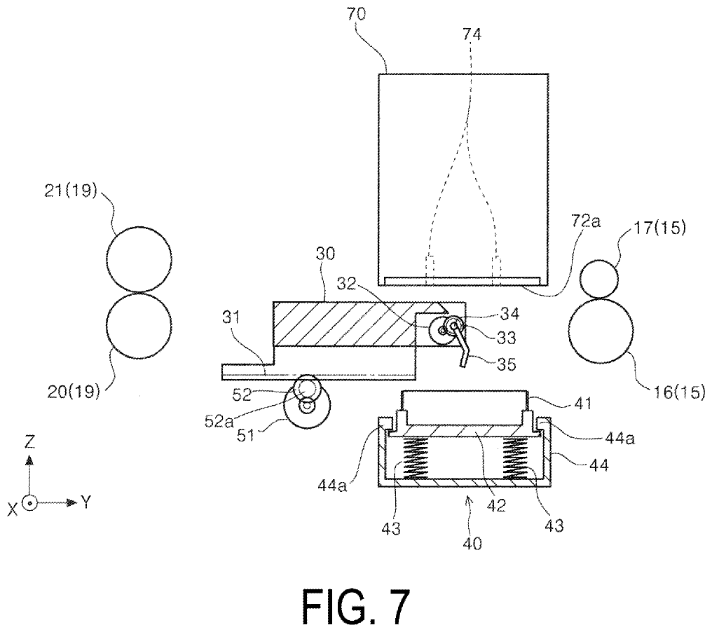

A gear 33 is provided at an end portion of the shaft 34 on one side in the medium width direction, for example, an end portion in the +X direction. The gear 33 is driven by a wiper rotary motor 32 which is an example of a second motor provided for the facing portion 30. The wiper rotary motor 32 is controlled by the control unit 50 (see FIG. 2). When the wiper rotary motor 32 rotates, the wiper 35 rotates around the shaft 34. As an example, FIGS. 5 and 6 illustrate a first posture in which the wiper 35 can come into contact with the head surface 72a, and FIGS. 4 and 7 illustrate a second posture in which the wiper 35 is farther from the head surface 72a than in the first posture.

When the wiper 35 rotates from the second posture toward the first posture, further rotation of the wiper 35 is restricted by a first rotation restriction portion (not illustrated), and a posture in a state in which the rotation is restricted is the first posture. When the wiper 35 rotates from the first posture toward the second posture, further rotation of the wiper 35 is restricted by a second rotation restriction portion (not illustrated), and a posture in a state in which the rotation is restricted is the second posture.

The control unit 50 can grasp that the wiper 35 is switched to the first posture based on an increase in the drive current value of the wiper rotary motor 32 when the wiper 35 abuts on the first rotation restriction portion. The control unit 50 can grasp that the wiper 35 is switched to the second posture based on an increase in the drive current value of the wiper rotary motor 32 when the wiper 35 abuts on the second rotation restriction portion. However, the method of detecting the posture of the wiper 35 is not limited thereto, and for example, a contact type or non-contact type sensor may be used to detect the posture of the wiper 35.

When wiping the head surface 72a by the wiper 35, the control unit 50 switches the wiper 35 to the first posture as a first step, as illustrated in FIG. 5, in the state illustrated in FIG. 4, that is, in a state in which the facing portion 30 is at the recording position and the wiper 35 is in the second posture. As a result, the wiper 35 is pressed against the head surface 72a. In the present embodiment, the wiper 35 presses against the head surface 72a when the wiper 35 is switched to the first posture, but the wiper 35 may be located upstream of the head surface 72a when the wiper 35 is switched to the first posture.

Next, as a second step, the control unit 50 moves the facing portion 30 from the recording position to the retreat position as indicated by the change from FIG. 5 to FIG. 6. As a result, the head surface 72a is wiped by the wiper 35. When the head surface 72a is wiped by the wiper 35, the line head 70 is located at the first ink discharge position as an example, but the present disclosure is not limited thereto, and may be located at other positions.

When the wiper 35 is separated from the head surface 72a in the −Y direction, the wiper 35 deformed by being pressed against the head surface 72a returns to the original shape, and thus the ink attached to the wiper 35 may be scattered at that time. In order to suppress such a problem, it is also preferable to control the wiper rotary motor 32 to rotate the wiper 35 in a direction away from the head surface 72a before the wiper 35 is separated from the head surface 72a so as to reduce the degree of pressing of the wiper 35 against the head surface 72a or to separate the wiper 35 from the head surface 72a.

Next, as a third step, the control unit 50 switches the wiper 35 from the state in FIG. 6 to the second posture, and as a fourth step, moves the facing portion 30 from the retreat position to the recording position. When the head surface 72a is wiped by the wiper 35, the cap unit 40 is held at the descent position from the state illustrated in FIG. 4 through the states illustrated in FIGS. 5, 6, and 7 to the state illustrated in FIG. 4 again.

In this case, when moving the facing portion 30 from the retreat position to the recording position in the fourth step, the control unit 50 may stop the facing portion 30 for a predetermined time in a state in which the wiper 35 in the second posture is positioned above the cap portion 41 as illustrated in FIG. 7. Thus, the ink attached to the wiper 35 can be dropped to the cap portion 41 and collected by the cap portion 41.

At this time, it is preferable that the control unit 50 rotates the wiper 35 from the second posture to an intermediate posture between the second posture and the first posture at a first rotation speed and switches the wiper 35 from the intermediate posture to the second posture at a second rotation speed higher than the first rotation speed. Thus, the ink attached to the wiper 35 can be knocked down toward the cap portion 41.

The control unit 50 wipes the head surface 72a by the wiper 35 at a predetermined timing as described above. The wiping of the head surface 72a by the wiper 35 is performed, for example, before a series of print jobs is completed and the head surface 72a is covered with the cap portion 41 or after a flushing operation. The flushing operation is an operation of discharging ink from the line head 70 to the cap portion 41 and is performed at a timing when the cumulative number of printed sheets after the previous flushing operation reaches a predetermined number of sheets.

As described above, the printer 1 includes the line head 70 elongated in the medium width direction, the facing portion 30 disposed facing the line head 70, and the wiper 35 that moves in the medium conveying direction to wipe the head surface 72a of the line head 70. The facing portion 30 is movable, by moving along the medium conveying direction by the power of the facing portion moving motor 51, to the recording position, which is the position of the facing portion 30 when recording is performed on the medium and at which the facing portion 30 faces the line head 70, and the retreat position to which the facing portion 30 retreats from the recording position. The wiper 35 is provided at the facing portion 30 switchably between the first posture in which the head surface 72a can be wiped and the second posture in which the wiper 35 is farther from the head surface 72a than in the first posture. The wiper 35 wipes the head surface 72a by moving the facing portion 30 along the medium conveying direction in a state in which the wiper 35 is in the first posture.

Since the wiper 35 is provided on the facing portion 30 in this manner, a dedicated holder for providing the wiper 35 is unnecessary, and it is possible to suppress an increase in the size of the device while installing the wiper 35. Further, since the wiper 35 wipes the line head 70 elongated in the medium width direction while moving along the medium conveying direction, the wiping time can be shortened.

In the present embodiment, the second posture of the wiper 35 is a posture in which the wiper 35 extends vertically downward and is a posture far away from the medium conveyance path, so that the attachment of paper dust or the like to the wiper 35 can be suppressed.

However, the second posture of the wiper 35 may be any posture as long as it does not hinder the conveyance of the medium.

In the present embodiment, the wiper 35 is provided at an upstream position of the facing portion 30 in the medium conveying direction.

Since the medium is conveyed to the position facing the line head 70, that is, the liquid discharge position by the first conveyance roller pair 15, if the path length between the liquid discharge position and the first conveyance roller pair 15 becomes long, the posture of the medium is likely to become unstable, and there is a concern that the recording quality may deteriorate.

Here, if the wiper 35 is provided at a position downstream of the facing portion 30, when wiping the head surface 72a by the wiper 35, it is necessary to move the facing portion 30 upstream in the medium conveying direction. Accordingly, it is necessary to increase the path length between the liquid discharge position and the first conveyance roller pair 15, and the above-described recording quality is likely to deteriorate.

However, according to the present embodiment, since the wiper 35 is provided at a position upstream of the facing portion 30 in the medium conveying direction, it is possible to suppress an increase in the path length between the liquid discharge position and the first conveyance roller pair 15, and it is possible to suppress the above-described deterioration in recording quality.

Providing the wiper 35 at a position upstream of the facing portion 30 means that the wiper 35 is provided upstream of the center position (a position CL in FIG. 3) of the facing portion 30 in the medium conveying direction. Similarly, providing the wiper 35 at a position downstream of the facing portion 30 means that the wiper 35 is provided downstream of the center position (a position CL in FIG. 3) of the facing portion 30 in the medium conveying direction.

In the present embodiment, the wiper 35 is provided at a position upstream of the facing portion 30 in the medium conveying direction but may be provided at a position downstream of the facing portion 30. In this case, the retreat position of the facing portion 30 can be set upstream of the recording position in the medium conveying direction.

In the present embodiment, the wiper 35 switches between the first posture and the second posture by being rotated by the power of the wiper rotary motor 32 provided on the facing portion 30. This makes it possible to easily adjust the timing at which the posture of the wiper 35 is switched.

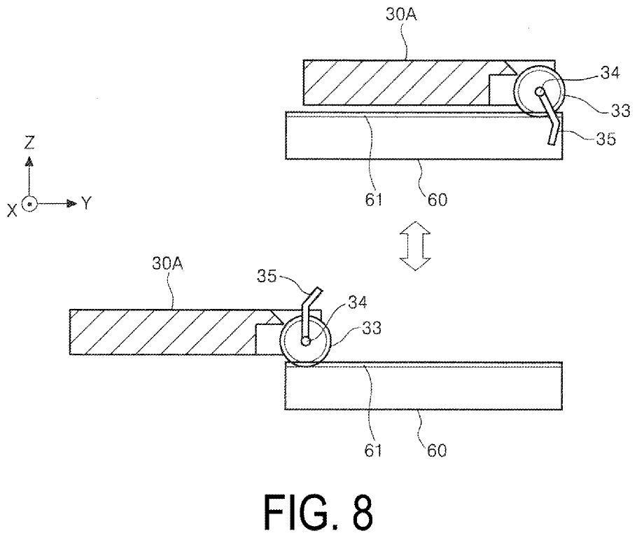

The wiper 35 can also be rotated without using a dedicated motor. FIG. 8 illustrates an example of such a configuration. The upper diagram of FIG. 8 illustrates the second posture of the wiper 35, and the lower diagram of FIG. 8 illustrates the first posture of the wiper 35.

A pinion gear 37 is provided on the shaft 34 which is the rotation shaft of the wiper 35. Note that the pinion gear 37 is not fixedly provided with respect to the shaft 34, is coupled via a friction member (not illustrated), and is configured such that rotational torque is transmitted from the pinion gear 37 to the shaft 34 via a frictional force.

A rack member 60 is disposed below the facing portion 30A, and a rack portion 61 is formed at the rack member 60 along the medium conveying direction. The pinion gear 37 meshes with the rack portion 61.

When the facing portion 30A moves toward the retreat position in a state in which the facing portion 30A is at the recording position as illustrated in the upper diagram of FIG. 8 and the wiper 35 is in the second posture, the pinion gear 37 rotates by meshing with the rack portion 61, and the wiper 35 rotates as indicated by the change from the upper diagram to the lower diagram of FIG. 8 and switches from the second posture to the first posture.

According to such a configuration, the wiper 35 can be rotated without using a dedicated motor.

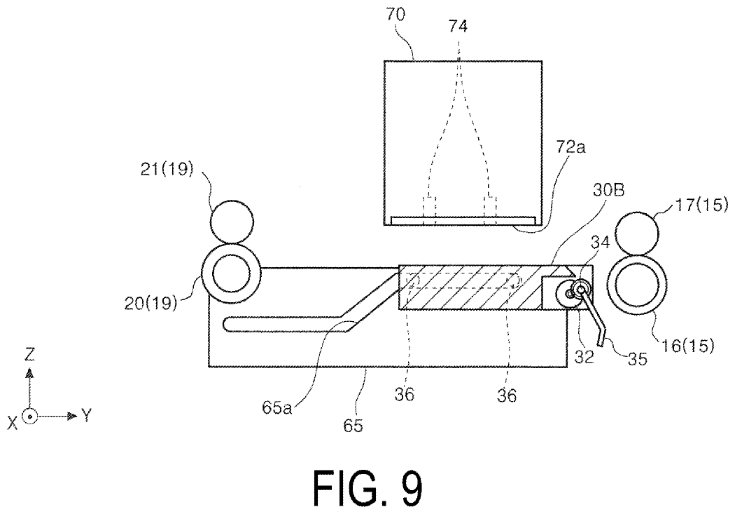

Next, another embodiment of the facing portion 30 will be described with reference to FIGS. 9 to 13.

Referring to FIG. 9, reference sign 65 denotes a guide member for guiding a facing portion 30B to the recording position and the retreat position. Although not illustrated, the guide members 65 are arranged on both sides of the facing portion 30B so as to sandwich the facing portion 30B in the medium width direction.

A guide hole 65a is formed in the guide member 65. The guide hole 65a extends in parallel along the medium conveying direction from the upstream end toward the downstream in the medium conveying direction, then inclines downward toward the downstream, and again extends in parallel along the medium conveying direction.

The facing portion 30B is provided with bosses 36 in both side portions in the medium width direction. In the present embodiment, two bosses 36 are provided at intervals along the medium conveying direction. The two bosses 36 enter the guide hole 65a and are guided by the guide hole 65a.

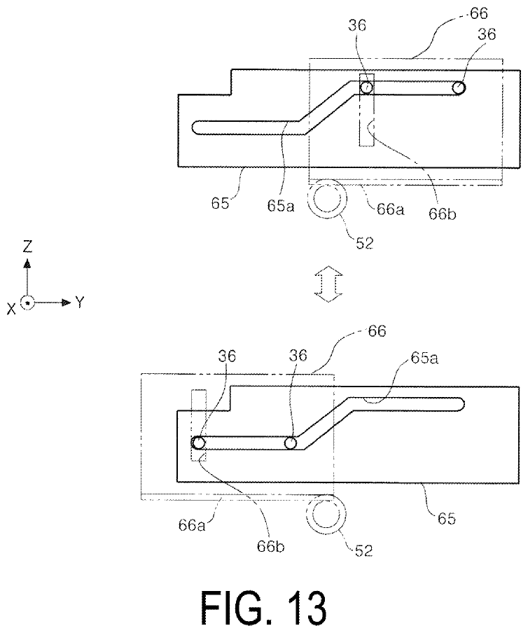

On the further outer side in the medium width direction with respect to the guide member 65, rack members 66 illustrated in FIG. 13 are provided on both sides with respect to the facing portion 30B so as to sandwich the facing portion 30B and the guide member 65. The rack member 66 is supported by a guide member (not illustrated) so as to be displaceable along the medium conveying direction. A pinion gear 52 that displaces the facing portion 30B meshes with a rack portion 66a formed at the rack member 66. When the pinion gear 52 is rotated by the power of a facing portion moving motor 51 (see FIG. 2), the rack member 66 is displaced along the medium conveying direction.

An elongated hole 66b extending in the vertical direction is formed in the rack member 66. One of the bosses 36 provided in the facing portion 30B is longer in the medium width direction than the other bosses 36 and enters the elongated hole 66b. Therefore, when the rack member 66 is displaced in the medium conveying direction, the boss 36 that has entered the elongated hole 66b, that is, the facing portion 30B is displaced in the medium conveying direction. Here, when the boss 36 passes through the inclined portion of the guide hole 65a, the boss 36 is displaced in the vertical direction, but the elongated hole 66b of the rack member 66 extends in the vertical direction, whereby the boss 36 can be displaced in the elongated hole 66b in the vertical direction. With such a configuration, the boss 36, that is, the facing portion 30B can be displaced along the guide hole 65a by the rack member 66 as indicated by the change from the upper diagram to the lower diagram in FIG. 13 or as indicated by the change from the lower diagram to the upper diagram in FIG. 13.

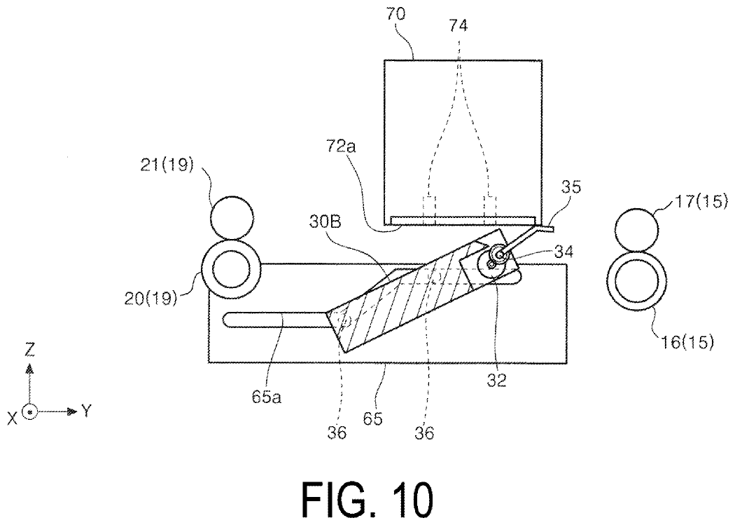

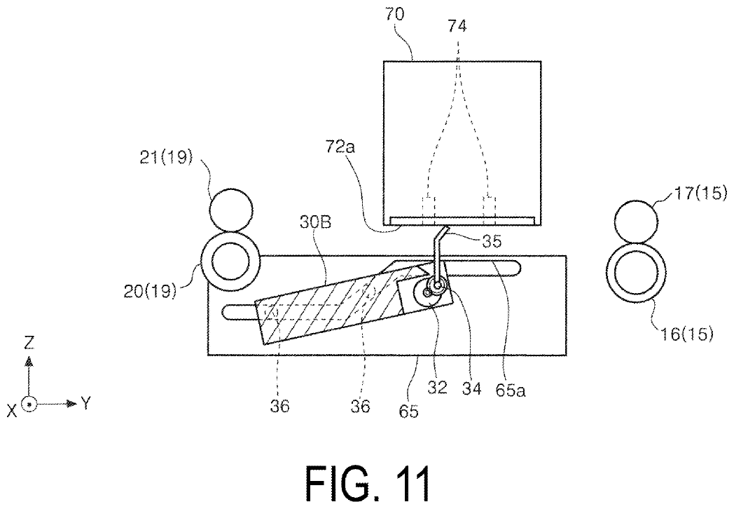

When wiping a head surface 72a with a wiper 35, a control unit 50 rotates the wiper 35 toward the head surface 72a in the state illustrated in FIG. 9, that is, in the state in which the facing portion 30B is at the recording position and the wiper 35 is in the second posture. Here, as illustrated in FIGS. 10 and 11, since the interval between the position upstream of the facing portion 30B and the head surface 72a changes according to the posture change of the facing portion 30B, the control unit 50 adjusts the posture of the wiper 35 according to the position, that is, the posture of the facing portion 30B. That is, the posture of the wiper 35 is controlled so as make the force when the wiper 35 is pressed against the 72a of the head surface as uniform as possible. Specifically, in the present embodiment, the distance between the wiper 35 and the head surface 72a increases as the facing portion 30B moves from the recording position to the retreat position.

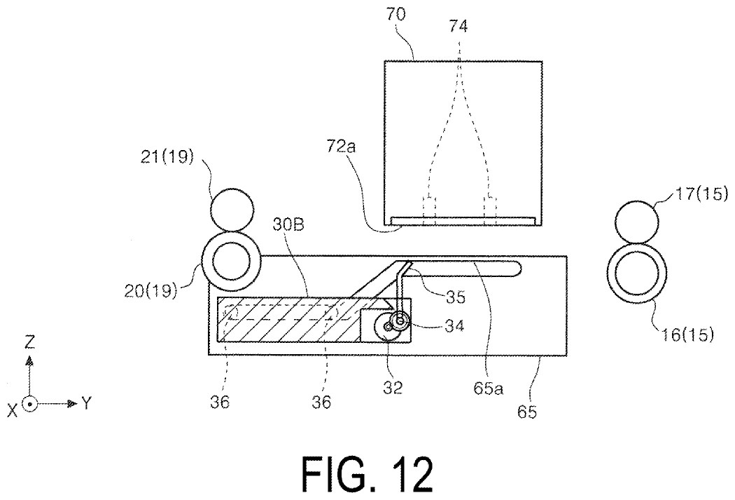

Accordingly, as the facing portion 30B moves downstream, the control unit 50 rotates the wiper 35 in the counterclockwise direction in FIG. 12 as indicated by the change from the state in FIG. 10 to the state in FIG. 12 through the state in FIG. 11. As described above, in the present embodiment, the first posture which is a posture when the wiper 35 wipes the head surface 72a is not constant but changes.

When the facing portion 30B is located at the retreat position as illustrated in FIG. 12, the facing portion 30B is located below the second conveyance roller pair 19. With such a configuration, the following operational effects are obtained.

If the facing portion 30B horizontally moves along the medium conveying direction, the second conveyance roller pair 19 needs to be arranged further downstream in order to avoid interference between the second conveyance roller pair 19 arranged downstream of the facing portion 30B and the facing portion 30B. When the second conveyance roller pair 19 is disposed further downstream, the distance between the first conveyance roller pair 15 and the second conveyance roller pair 19 increases. As a result, the posture of the medium tends to be unstable at the position facing the line head 70, that is, the liquid discharge position, and the recording quality may deteriorate.

However, as described above, since the facing portion 30B at the retreat position is located below the second conveyance roller pair 19, the second conveyance roller pair 19 can be disposed further upstream. This makes it possible to suppress the deterioration of the recording quality.

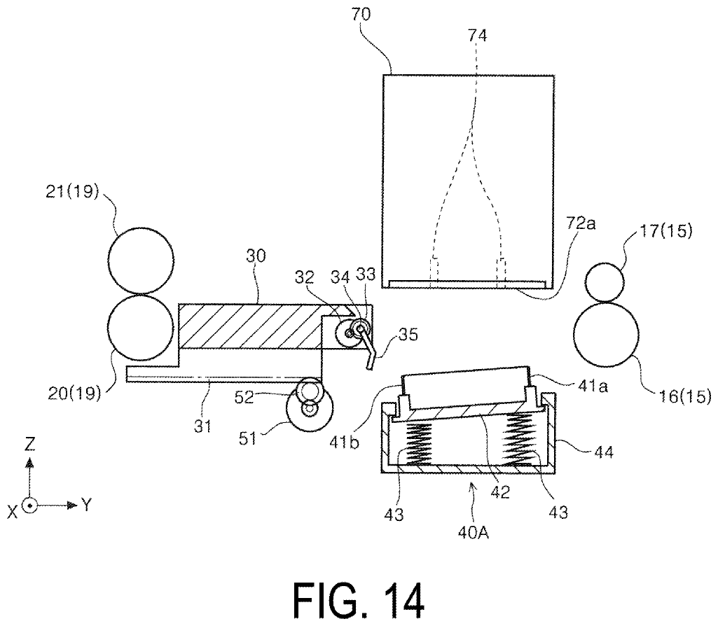

Next, still another embodiment will be described with reference to FIGS. 14 to 16.

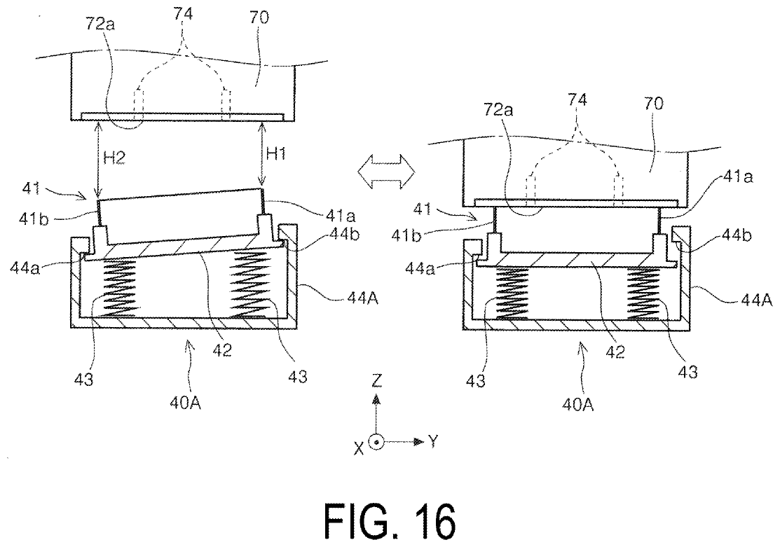

In the present embodiment, the configuration of the cap unit is different from that of the above-described embodiment. As illustrated in FIG. 16, in a cap unit 40A according to the present embodiment, a restriction portion that defines the movement limit of a cap support portion 42 in the +Z direction in a base portion 44A includes a restriction portion 44a downstream in the medium conveying direction and a restriction portion 44b that is a restriction portion upstream in the medium conveying direction and that is located farther in the +Z direction than the restriction portion 44a. As a result, in a cap portion 41, a second edge portion 41b downstream is positioned farther in the −Z direction than a first edge portion 41a upstream. As illustrated in FIG. 3, the first edge portion 41a is an edge portion of the cap portion 41 having a rectangular shape in plan view in the +Y direction, that is, the upstream edge portion in the medium conveying direction, and the second edge portion 41b is an edge portion of the cap portion 41 in the −Y direction, that is, the downstream edge portion in the medium conveying direction. The cap portion 41 includes the first edge portion 41a and the second edge portion 41b and has a rectangular shape in plan view.

The left diagram in FIG. 16 illustrates a state in which the cap portion 41 is separated from a head surface 72a, and in this state, a distance H2 between the second edge portion 41b and the head surface 72a is longer than a distance H1 between the first edge portion 41a and the head surface 72a. As a result, the cap portion 41 is in an inclined state. However, as illustrated in the right diagram in FIG. 16, in a state in which the cap portion 41 covers the head surface 72a, the cap portion 41 is pushed down by the head surface 72a, and the inclined state of the cap portion 41 is canceled and becomes parallel to the head surface 72a.

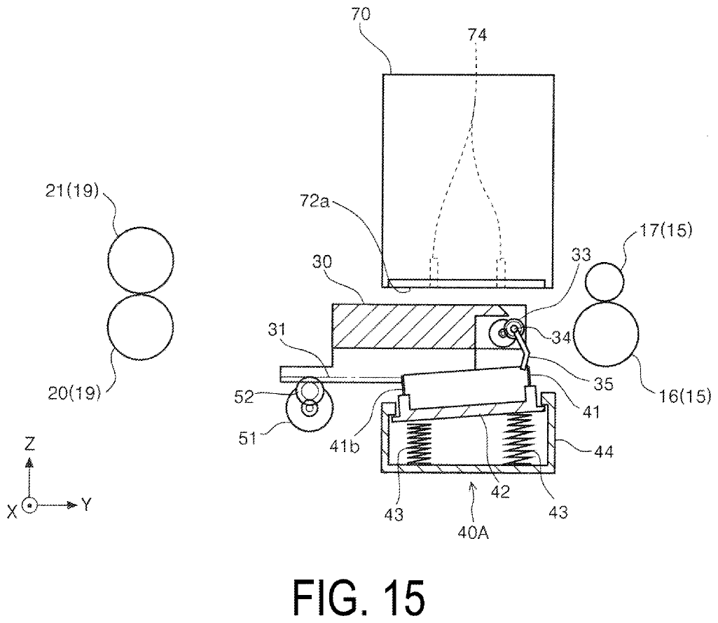

In the configuration including the cap unit 40A described above, a wiper 35 has such a height relationship that it comes into contact with the first edge portion 41a of the cap portion 41, as illustrated in FIG. 15, when the wiping of the head surface 72a by the wiper 35 is finished and a facing portion 30 returns to the recording position from the state in FIG. 14, that is, the state in which the facing portion 30 is at the retreat position and the wiper 35 is in the second posture. Accordingly, the ink attached to the wiper 35 can be removed by the first edge portion 41a of the cap portion 41. Furthermore, since the removed ink is taken into the cap portion 41, the ink removed using the existing configuration can be sent to the waste liquid collection unit (not illustrated).

It is needless to say that the present disclosure is not limited to each embodiment described above or modification examples, and various modifications are possible within the scope of the present disclosure as described in the appended claims, which also fall within the scope of the present disclosure.

What is claimed is:

1. A recording device comprising:
a liquid discharge head including a plurality of nozzles configured to discharge liquid to a medium, the liquid discharge head being elongated in a medium width direction, the medium width direction being a direction intersecting a medium conveying direction;
a facing portion disposed facing the liquid discharge head; and
a wiper configured to wipe a head surface of the liquid discharge head by moving in the medium conveying direction with respect to the liquid discharge head, wherein
the facing portion is movable, by moving along the medium conveying direction by power of a first motor, to a recording position at which the facing portion faces the liquid discharge head and a retreat position to which the facing portion retreats from the recording position, the recording position being a position of the facing portion when recording is performed on the medium,
the wiper is provided at the facing portion switchably between a first posture in which the wiper is configured to wipe the head surface and a second posture in which the wiper is farther from the head surface than in the first posture, and
the wiper wipes the head surface when the facing portion moves along the medium conveying direction with the wiper being in the first posture.

2. The recording device according to claim 1, further comprising
a first conveyance roller pair located upstream of the facing portion in the medium conveying direction and configured to convey the medium, wherein
the wiper is provided at a position upstream of the facing portion in the medium conveying direction.

3. The recording device according to claim 2, wherein
the wiper switches between the first posture and the second posture by being rotated by power of a second motor provided at the facing portion.

4. The recording device according to claim 3, wherein
a control unit configured to control the first motor and the second motor performs
a first step of switching the wiper to the first posture in a state in which the facing portion is at the recording position and the wiper is in the second posture and
a second step of moving the facing portion from the recording position to the retreat position.

5. The recording device according to claim 4, further comprising
a cap portion located below the facing portion at the recording position and configured to cover the head surface, wherein
at least one of the liquid discharge head or the cap portion is provided movably in a direction of advancing and retreating with respect to the other of the liquid discharge head or the cap portion,
the cap portion covers the head surface when at least one of the liquid discharge head or the cap portion advances with respect to the other of the liquid discharge head or the cap portion, and
when moving the facing portion from the retreat position to the recording position with the cap portion located below the facing portion after execution of the second step, the control unit brings the wiper into the second posture and stops the facing portion for a predetermined time with the wiper located above the cap portion.

6. The recording device according to claim 2, further comprising
a second conveyance roller pair located downstream of a position facing the liquid discharge head in the medium conveying direction, the second conveyance roller pair being configured to convey the medium, wherein
the facing portion located at the retreat position is located below the second conveyance roller pair.

7. The recording device according to claim 6, wherein
the second conveyance roller pair includes
a driven roller configured to come into contact with a first surface facing the liquid discharge head of a medium and
a driving roller configured to come into contact with a second surface opposite to the first surface.

8. The recording device according to claim 4, further comprising
a cap portion located below the facing portion at the recording position and configured to cover the head surface, wherein
at least one of the liquid discharge head or the cap portion is provided movably in a direction of advancing and retreating with respect to the other of the liquid discharge head or the cap portion,
the cap portion covers the head surface when at least one of the liquid discharge head or the cap portion advances with respect to the other of the liquid discharge head or the cap portion,
the cap portion includes a first edge portion extending in a width direction intersecting the medium conveying direction and configured to come into contact with the head surface and a second edge portion located downstream of the first edge portion in the medium conveying direction, a distance between the second edge portion and the head surface being longer than a distance between the first edge portion and the head surface in a state in which the cap portion is separated from the liquid discharge head,
when moving the facing portion from the retreat position to the recording position with the cap portion located below the facing portion after execution of the second step, the control unit brings the wiper into the second posture, and
the wiper comes into contact with the first edge portion when the facing portion moves from the retreat position to the recording position with the wiper being in the second posture.
